(19) United States
(12) Patent Application Publication
(10) Pub. No.: US 2005/0039041 A1
(43) Pub. Date: Feb. 17, 2005

(54) Access, identity, and ticketing system for providing multiple access methods for smart devices

(76) Inventors: Mari Myra Shaw, Philadelphia, PA (US); Joseph Murray, Yardley, PA (US)

Correspondence Address: JEFFREY L. BRANDT;c/o PORTFOLIO IP, P.O. BOX 52050, MINNEAPOLIS, MN, 55402, US

(21) Appl. No.: 10/846,005

(22) Filed: May 14, 2004

Related U.S. Application Data
(63) Continuation of application No. PCT/US02/36054, filed on Nov. 12, 2002.
(60) Provisional application No. 60/332,210, filed on Nov. 14, 2001.

(51) Int. Cl. H04L 9/32

(52) U.S. Cl. 713/200

(57) ABSTRACT

Disclosed is a system for accurately storing and reading digital identifications and permissions with an access rights management component that protects the privacy and integrity of the data stored on a smart device such as a smart card. The invention is intended to enable effective use of smart cards for applications such as air travelers identity, medical information such as history and prescriptions, or secure employee access cards. Multiple levels of security are permitted to ensure that users of the data, programs, and other resources stored on the card may access only that data that they have been authorized to. The use of a single card for multiple user roles necessitates multiple access methods to the card. For example, in a medical information or prescription card scenario, the cardholder may be the patient, and be able to access their personal patient data which is stored on the card with a PIN, password, or passphrase, by entering the aforementioned code on a computing device (10) which is attached to a card reader/writer device (20) which has the patient's card (22) inserted into it. That patient's doctor may be provided access to data on the same card, which may or may not include the patient's data by entering an alternate code, or providing a digital signature to the card from his or her card authorizing the doctor to write prescription information or update medical history. In this example, the patient would have read-only access to the data that the doctor had written. The technology disclosed in the invention is also intended for travelers' identification, which could hold biometric identity information, ticketing and/or boarding information, and federal information about the cardholder which would permit or prohibit the cardholder from traveling on airline flights.

### RELATED APPLICATIONS

This application is a continuation under 35 U.S.C. 111(a) of PCT/US02/36054, filed Nov. 12, 2002 and published on Jun. 12, 2003 as WO 03/048892, which claimed priority to U.S. Provisional Application No.: 60/332,210, filed Nov. 14, 2001, which applications and publications are incorporated herein by reference.

### BACKGROUND OF THE INVENTION

1. Field of the Invention

This invention relates to smart devices and more particular to methods and systems for securing access to data on smart devices.

2. Description of the Related Technology

Currently, personal identity checks used in systems such as airline security or any activity for which tickets are required at best rely on a visual check with a photo ID together with a short person-to-person question and answer dialog to determine if a person seeking entry is the person he claims to be. There is rarely any further or extended validation completed to confirm the identity of the individual. Identity checks and information transferals for medical applications such as prescription fulfillment at a pharmacy are still being accommodated by a handwritten slip of paper.

Distractions, visual fatigue, and the very subjective nature of identifying an individual by visual examination of a drivers license or other picture ID makes this an error prone and unreliable means of accomplishing the task of individual identification. Individuals may also fairly easily and effectively disguise either themselves or the graphical picture identification card to forge their identity for the purposes of traveling undetected and virtually untraceable. Furthermore, even if identity is established accurately, current identification systems do not support the storage of information relevant to the characteristics of the individual (e.g. felony convictions, potential terrorist threat). Also, because the information contained on the ID is visually read and interpreted, inaccuracies arise because information may be handwritten, or could be simply misread by the inspecting authority.

The existing identity system using printed ID cards assumes only 2 roles: one of the cardholder and one of the inspector. Most commonly, everyone who inspects an ID has access to the same information. There is no means of securing card-bound identity data for use only for those with the proper authority to inspect this data. For this reason, the amount and type of data stored on an ID card is constrained to the lowest common denominator.

Furthermore, the current system of visual inspection by an agent or employee of the airline only provides limited information about the cardholder. The information is typically static, in that it relies on printed media, and cannot be easily updated without a reissuance of the card or identification.

The present invention relates generally to smart cards, smart card applets, applications, programs, files, and resources, computer security, identity cards, biometric identity systems, computer transactions, and computer software applications and addresses these and other problems.

### SUMMARY OF THE INVENTION

The present invention provides a software system and method for enabling an entity, referred to herein as the “authorizing agent” to efficiently and accurately identify an individual and multiple characteristics about the individual by using a secure smart card and a computing device. Once the authorizing agent has secured the identity of the individual, data may be read, written, updated, or deleted on the individual's smart card for future identification, portable data storage, or as a step in an asynchronous transaction. An example of an asynchronous transaction with respect to the present invention might be the process of a medical prescription being written and later filled. One step in the transaction involves the doctor writing the information, amount, and conditions of the drug prescription at his or her office. The next step involves removing the card from the device and the patient taking it to a pharmacy, having the pharmacist insert the card into his or her computing device, and reading the data so that the prescription may be filled. The smart card may then be updated by the pharmacist to show where and when the prescription had been filled, or via electronically communicating the data from the smart card to a computer system that the doctor may access. Because these steps happen over an extended time period, and its component steps are not part of a single discrete system, it may be characterized as asynchronous.

The present invention describes a method and system that will immediately allow for greater security via more and better means of identifying an individual and reporting multiple characteristics of that individual. The invention also provides an infrastructure for even greater control and audit of controlled access to venues which require ticketing and other secure access means by providing a writable, updatable apparatus, the smart card, which can be accessed quickly and accurately through a computer network to contain new or updated information about an individual which may affect his or her qualification to gain access to the controlled or ticketed venue, or to take a particular drug. For instance, record of a felony conviction that prohibits international travel can very quickly and easily be written to the individual's travel card so that this restriction can be easily brought to the attention of an operator or agent of the airline at any point, from purchase of a ticket to the departure site. The present invention allows for the storage and retrieval of history, biometric data, and other data which may be updated at any point that the card is authenticated and inserted into a reader with an agent who is authorized to update card records.

In accordance with one aspect of the invention, a smart device is provided, comprising: a data storage apparatus on the smart device; a plurality of data resources in the data storage apparatus on the smart device; a user role determination apparatus on the smart device for determining the role of a user requesting access to at least one of the plurality of data resources; and at least one permission apparatus on the smart device operative to receive the role of the user from the user role determination apparatus and to control based on the role of the user the access of the user to the plurality of data resources.

In accordance with another aspect of the invention, a method is provided for selectively controlling access by multiple users to a plurality of data resources on a smart device, the method comprising the steps of: determining the identity of a user requesting access to at least one of the plurality of data resources on the smart device; determining the role of the user; and controlling, based on the role of the user, the access of the user to the plurality of data resources.

In accordance with another aspect of the invention, a method of operating a smart device is provided, the device containing a plurality of data resources, the method comprising the steps of: receiving from a user a request to access at least one of the plurality of data resources on the smart device; determining a role of the user requesting access to at least one of the plurality of data resources; determining a plurality of permissions stored on the card; and supporting, based on the role of the user and the plurality of permissions, access of the user to the plurality of data resources.

In accordance with another aspect of the invention, a system for operating a smart device containing a plurality of data resources is provided, comprising: receiving apparatus connected to receive a user request to access at least one of the plurality of data resources on the smart device; determining apparatus connected to receive the request from the user and determine a role of the user; a memory on the smart device storing a plurality of permissions; and permissioning apparatus responsive to the role of the user and the plurality of permissions to provide access to the user to at least one of the plurality of data resources.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a block diagram of a smart card system using a standard desktop computer configuration.

FIG. 2 is a diagram of a smart card system using a standard desktop computer configuration connected to a network.

FIG. 3 is a diagram showing an exemplary organization which graphically explains the relationship between user roles and smart card resource types in a healthcare prescription smart card application.

FIG. 4 is a diagram showing an exemplary organization which graphically explains the relationship between user roles and smart card resource types in an airline travel smart card application.

FIG. 5 is an exemplary diagram showing multiple means of access to a smart card.

FIG. 6 is an exemplary chart showing multiple default permission relationships for card data.

### DETAILED DESCRIPTION OF THE PREFERRED EMBODIMENT(S)

The present invention describes a smart card based access system that enables identity and prejudicial access to data stored on the card based on the authority of the party who has requested card access. In this context, a smart-card enabled system 10 may be a stand-alone unit of the type shown in FIG. 1, including a host computer 12, user input/output devices such as a keyboard 14, a pointing device or mouse 16 and a display screen 18. A conventional smart card reader or terminal 20 is connected to host computer 12, with a smart card 22 shown inserted for reading and/or writing in terminal 20.

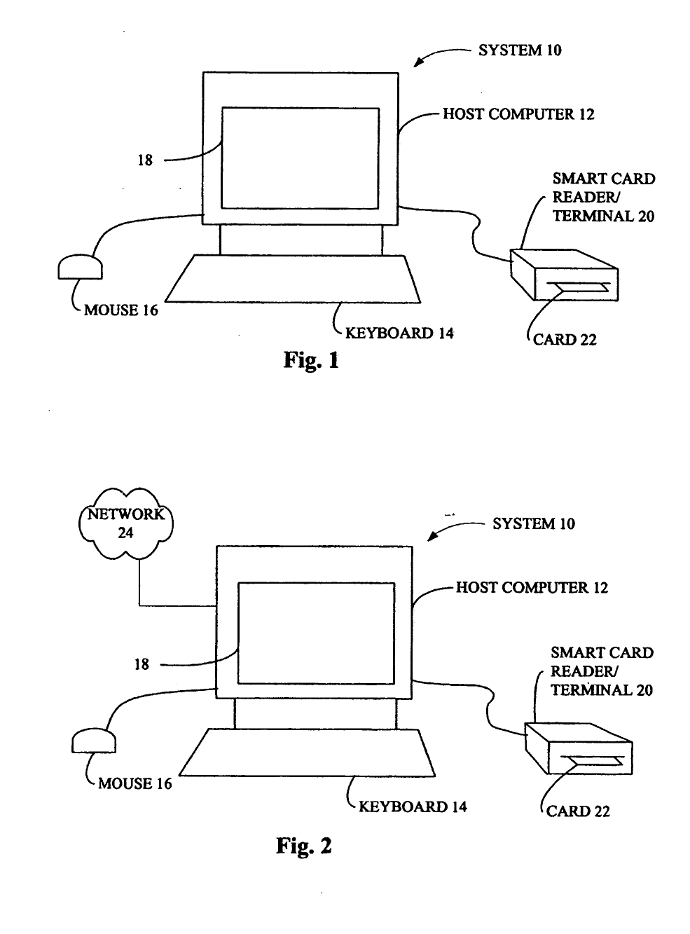

Alternatively, computer system 10 may be connected to a network 24 as shown in FIG. 2 (wherein like elements to FIG. 1 are indicated by like reference numerals). Network 24 may comprise one or more of many networks such as the Internet, a VPN (Virtual Private Network), an enterprise network, or an intranet.

The identity and access system disclosed herein is accomplished by means of a simple, yet comprehensive permissioning system, which involves multiple access levels, and can be even further customized by an administrative user. The permissioning system is realized by the relationship between two defined entities, one example of which is illustrated in FIG. 3.

With reference now to FIG. 3, a two entity system 25 includes an entity, represented by block 26, that illustrates data resource types stored on the smart card. A block 30 illustrates the user role of the person or system attempting to access the card. This is based on the premise that more than one type of user may need access to an individual's card for any example application, but that any given user may have legitimate rights to access certain card resources, but have no rights to access others.

Continuing with the example illustrated in FIG. 3, if a smart card is used to store medical prescription information, such prescription information includes physician data 26-1 and cardholder data 26-2. The cardholder data 26-2 includes private data 26-3 of limited access and public data 26-4 of general access, the balance of the card holder data 26-2 accessible to the card holder. Prescription data 26-5, for example, may include data available only for access by the physician as well as data only accessible by an authorized private party such as a pharmacist.

The user entities illustrated in user block 26 include the card holder 30-1, one or more pharmacists 30-2, one or more doctors 30-3 and others 30-4 with access to the public data. The card holder 30-1, in this case the patient, and her doctor 30-3 may have rights to examine the drug and prescription fulfillment information which is stored on the card, but a representative of the insurance company may not have rights to view or change this information. Pharmacist 30-2 may, for example, have access to read and update fulfillment information within private data 26-3 of prescription data 26-2, but read-only access to the prescription entered as physician data 26-1 of prescription data 26-2.

The cardholder (patient) 30-1 will have all rights to public data and may have rights to certain or all private cardholder data, but may have only read access to data to prescriptions that her doctor has written. Conversely, some data that is stored on the card may be characterized as ‘public,’ i.e. the data stored in public data 26-4, so that anyone who reads the card may quickly and easily find this data. An example of ‘public’ data may be organ donor information, blood type, drug allergies, the cardholder's basic information (name, insurance ID and Group numbers), and emergency telephone and contact information.

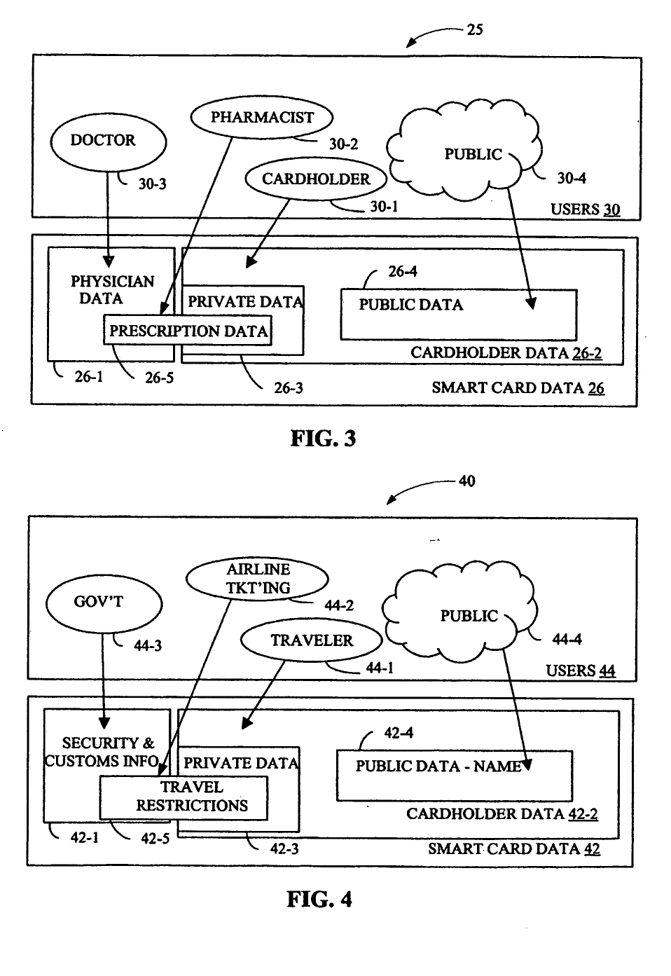

With reference now to FIG. 4, another two entity system 40 includes an entity, represented by block 42, that illustrates data resource types stored on the smart card. A block 44 illustrates the user role of the person or system attempting to access the card. This is based on the premise that more than one type of user may need access to an individual's card for any example application, but that any given user may have legitimate rights to access certain card resources, but have no rights to access others.

Continuing with the example illustrated in FIG. 4, if a smart card is used to store airline travel and ticketing information, such information includes securities and customs data 42-1 and cardholder data 42-2. The cardholder data 42-2 includes private data 42-3 of limited access and public data 42-4 of general access, the balance of the card holder data 42-2 accessible to the card holder. Travel restriction data 42-5, for example, may include data available only for access by securities and customs as well as data only accessible by an authorized private party.

The users entities illustrated in user block 44 include the card holder or traveler 44-1, one or more airline ticketing agents 44-2, one or more government agencies 44-3 and others 44-4 with access to the public data.

The cardholder (patient) 44-1 will have all rights to public data and may have rights to certain or all private cardholder data, but may have only read access to data to travel restrictions. Conversely, some data that is stored on the card may be characterized as ‘public,’ i.e. the data stored in public data 44-4, so that anyone who reads the card may quickly and easily find this data. An example of ‘public’ data may be the cardholder's basic information and emergency telephone and contact information.

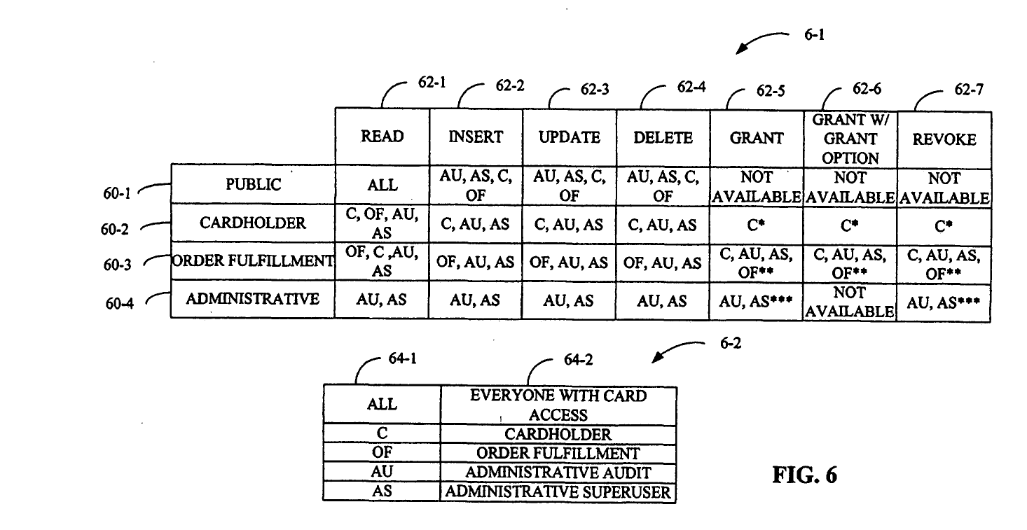

A detailed view of a permissioning system for the preferred embodiment is shown in FIG. 6 which explains a comprehensive set of rules that can easily be encoded into a software development kit so that the underlying fundamentals of security and accuracy are preserved, while allowing a custom application to be developed to meet unique business requirements. With particular reference now to FIG. 6, a first exemplary table 6-1 is shown including four rows 60-1 through 60-4 showing user roles and seven columns 62-1 through 62-7 showing permissions granted those users to various data resources. More particularly, the user roles include: public, cardholder, order fulfillment and administrative. The permissions include: read, insert, update, delete, grant, grant with grant option and revoke. The intersections in table 6-1 of user roles and permissions contain codes indicating the particular user type having the permission, the codes described in a second table 6-2 showing a column 64-1 of five codes and a corresponding column 64-2 of code descriptions. More particularly, code “ALL” corresponds to “EVERYONE WITH CARD ACCESS,”“C” corresponds to “CARDHOLDER”, “OF” corresponds to “ORDER FULFILLMENT, ”“AU” corresponds to “ADMINISTRATIVE AUDIT, ” and “AS” corresponds to “ADMINISTRATIVE SUPERUSER.”

The intersections of columns 60-1 through 60-4 with the rows 62-1 through 62-7 thus indicate who, as identified in table 6-2, is authorized to perform the function.

The permissioning system described in FIG. 6 relies on rules that determine any ‘role’ to access data that has been classified as any given ‘data resource type’. The terms are defined below.

With respect to data resource types, in the described embodiment of the invention, a data resource can be a file, applet, application, program, directory, folder or any accessible data component to be stored on the smart card. If a data resource is a directory or folder, the files it contains inherit the permissions and access rights of the folder. File access rights can never supersede the rights of their container folders or directories. Thus, permissions include access to data resources. For example, one could never create a folder with type ‘Order Fulfillment’ and give users of role ‘Member’ insert rights into files in that folder.

With respect to public data access (60-1), in the described embodiment of the invention, anyone can read public data. Access to Public data on a smart card typically is not protected by PIN. Access to the various permissions are set out in rows 62-1 through 7 of column 60-1.

With respect to order fulfillment data access (60-3), in the described embodiment of the invention, data resources classified as ‘Order Fulfillment’ is data that has use or relevance to order fulfillment authorities such as authorized ticketing, customs, or medical personnel. Ordinarily, a Cardholder can read some or all of the data but often will not be able write Order Fulfillment data. For example data classified as Order Fulfillment may not be available for the cardholder to read. For example, with respect to travel, only airline or security personnel may view this data. Cardholder role members can grant some permissions to members of Order fulfillment role. Members of Order fulfillment role can read and write. Access to the various order permissions are set out in rows 62-1 through 7 of column 60-3.

With respect to cardholder data access (60-2), in the described embodiment of the invention, Cardholder Data is that which has use or relevance to cardholder and may be changed by the cardholder (e.g. a list of proxies for living will, organ donation information. Ordinarily, information such as prescriptions and travel itineraries while of use to the cardholder are not candidates for this data resource type because the cardholder ordinarily does not have authority to change, delete, or add this data. Ordinarily, it should instead be assigned to the Order Fulfillment data resource type). Access to the various cardholder permissions is set out in rows 62-1 through 7 of column 60-2.

With respect to administrative data resource (60-4), in the described embodiment of the invention, Administrative Data Resources can only be read, inserted, updated, or deleted by the administrative role. Access to the various administrative permissions is set out in rows 62-1 through 7 of column 60-4.

With respect to user permissions, again shown at the intersections of columns 60-1 through 60-5 with rows 62-1 through 62-7 in table 6-1, in the described embodiment of the invention, any user who may access any card data resource must be assigned to one or more user roles. The role under which a user requests the privilege of reading, writing, altering, deleting, or granting determines his or her authority to perform that activity.

With respect to the public user role, in the described embodiment of the invention, members of the Public role can read data which is typically considered unsecure or publicly available. Access is Read-Only to data resources marked Public. There is no write access available to Public Roles unless a data resource is created explicitly for this purpose (e.g. electronic coupons, loyalty points, etc.)

With respect to the cardholder user role, in the described embodiment of the invention, the cardholder can read all data areas that are not marked ‘administrative’ and can grant or revoke access permission to members of Order Fulfillment role.

With respect to the order fulfillment user role, in the described embodiment of the invention, the Order Fulfillment role is reserved for trusted parties who use card data for specific, trusted activities. For a healthcare card, Order Fulfillment may be a pharmacist who uses card data to fill or update a prescription. For travel, the Order Fulfillment role may be a ticketing authority. Order Fulfillment members can read and write data only in Order Fulfillment data resources, while having read-only access in Public and Cardholder data resources. In alternative embodiments of the invention, there may be multiple levels of authority who are not characterized as Cardholder or Administrative that may be accurately characterized as “Order Fulfillment” or “Enabling Authority” roles (e.g. “Order Fulfillment 1”, “Order Fulfillment 2” or “Enabling Authority 1”, “Enabling Authority 2”). Each of these roles may have separate and discrete rights to data stored on the card.

With respect to the administrative audit role, in the described embodiment of the invention, Administrative Audit has been granted access to all card data resources. Can write temporary or permanent access or use restrictions or permissions in all public and private data areas on the card.

With respect to the administrative superuser (root) role, in the described embodiment of the invention, Administrative Superuser is an extremely trusted role, reserved for parties with absolute authority over card use and permissions. For travel applications, this may be specially entrusted FBI or FAA employees. For healthcare applications, this may be the card issuing authority. Administrative Superusers can write all public and private card data areas, can create new roles, including administrative roles and grant specific access privileges to each.

The chart shown in FIG. 6 thus shows the rights management organization in terms of user roles and pre-defined data resource types. The concept is that there are generally definable categories of users and smart card data resources upon can be applied a simple set of access rules that will apply in a broad range of instantiations of the invention.

In the embodiment of the invention described by FIG. 6, the Cardholder role indicated at C* (column 60-2, rows 64-5, 6, and 7) may grant a ‘Cardholder Proxy’ role to another individual for specific Power of Attorney or Living Will circumstances. The purpose of this type of grant is not to identify the Cardholder Proxy as the Cardholder, but rather to allow the Cardholder Proxy to make decisions or to make Order Fulfillment grants on behalf of the Cardholder, should that individual not be able to personally conduct those activities.

In the embodiment of the invention described by FIG. 6., the grants indicated as “**” at row 60-3, columns 62-5, 6 and 7 can occur if member was given grant with grant option.

In the embodiment of the invention described by FIG. 6, the Administrative role grants indicated as “***” at row 60-4, columns 62-5 and 7, may only grant/revoke Read access to all non-public roles. This, in effect, makes the resource an ‘Administrative Read-Window’ to members of non-Administrative, non-Public roles.

With respect to administrative roles, in the described embodiment of the invention, Administrative Superuser role also has Create Role, Create Data Resource Type authority. Administrative Audit role may not create roles or resource types. This is why there is a distinction between the two Administrative roles.

With respect to grants and revokes, in the described embodiment of the invention, allowable Grants for any data resource are: Grant Read, Grant Insert, Grant Update, Grant Delete, Grant Resource (grants all of Read, Insert, Update, and Delete), and Grant Resource with Grant Option (same as Grant Resource, but allows Grantee to make grants to other users).

In the described embodiment of the invention, allowable Revokes are: Revoke Read, Revoke Insert, Revoke Update, Revoke Delete, Revoke Grant Option, Revoke Resource (this revokes Grant Option if it was granted) and Revoke All (which revokes all privileges that have been granted).

Further in the described embodiment of the invention, grants may also be given with Session Access Tokens. This allows the patient to determine how long a trusted party has access to a card data resource.

The underlying system and method enables many embodiments of the invention. Throughout the disclosure, the reader has seen examples of medical healthcare and travel ID embodiments, but the reader can easily deduce embodiments, for example, for corporate or government identification, event security management, driver's license applications, or international import/export applications, where an authority's rights and discrete levels of access need to be quickly, easily, and accurately discerned, and decisions may be authorized based on these determinations.

From the description above, key advantages of the invention become evident.

The use and implementation is direct enough to be deployed widely.

The invention is comprehensive enough so that it can be used, implemented, and customized to suit a variety of applications requiring access rights management for users and administrators. The invention does not require extensive programming to add additional functionality or customizations.

The invention is flexible. Built-in primitives must provide enough immediate utility for a broad variety of personal access management applications (e.g. Healthcare, Travel, Government ID).

The invention allows for extensibility of application. Definitions and rules must be able to be easily extended for special-purpose applications without disqualifying the basic tenets of the invention. For example, a Government ID card application would certainly require custom user roles, which could not be practically defined prior to a custom implementation. The invention must make provisions for defining custom roles that are subject to built-in access rights management standards.

Specifically, new applications of smart card technology are enabled by the invention.

Applications requiring multiple access methods are made possible. While enabling the flexibility of allowing multiple roles of users to access card data, a permissioning system consisting of discrete grants and revokes can maintain the data security and separation of data required for each accessing role.

The reader will see that the methods described herein will enable a more robust, accurate, and simple system for describing identity and authorized smart card data resource access than was possible before in that:

Cardholder identity can be discerned quickly and easily.

Multiple levels of card access are permitted, ensuring that the rights associated with the user's role are strictly enforced.

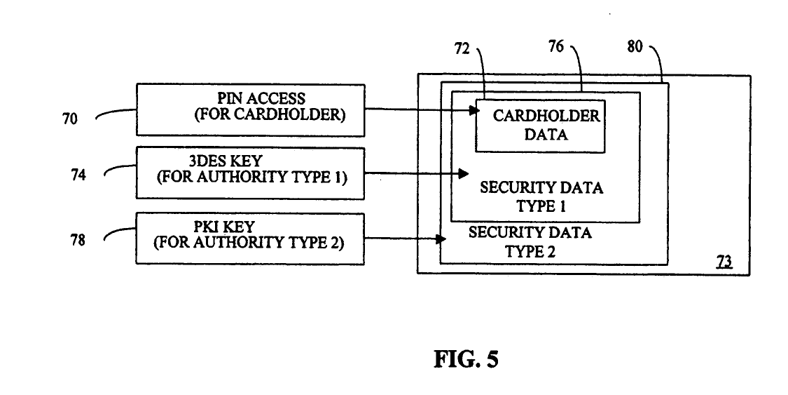

Multiple means of accessing the card are made possible. For example, as illustrated in FIG. 5, a PIN access 70 may be required for a user to access his/her own card data 72. An authorized third party may have a secure key in a 3DES embodiment 74 that may be submitted to a card 73 to only allow access to a first secure data type 76 within the predetermined rights of that role. A different authorized party may have a secure key in a PKI embodiment 78 that may be submitted to the card to only allow access to a second secure data type 80 within the predetermined rights of that role. An administrative ‘super user’ such as a representative of an authorized government body may gain administrative access to the card via:
a) a special PIN reserved for administrative access users
b) another key in a 3DES embodiment, or
c) a private key in a Public Key Infrastructure (PKI) embodiment.

The cardholders stored data may be updated quickly and easily within the constraints of the rights of an authorized accessing entity.

Smart card use and access is more flexible, being able to be used in a plurality of situations, with multiple types of access in multiple scenarios, while still maintaining the security and privacy enabled by single user access scenarios of the past.

Default roles (e.g. “cardholder”, “order fulfillment”, “administrative super-user”) may be used to satisfy the access requirements of a number of applications.

Custom user roles, data resource types, and access requirements may be written to the card for a specific application (commonly called “pre-issuance customization” or “personalization”).

Administrative users may create new roles, data resource types, and access requirements after the card has been issued.

There has thus been provided new and improved methods and systems for storing and accessing data on devices such as smart cards. The invention has been shown to have application in a variety of industries, including the travel industry, medical industry and others.

While the invention has been shown and described with respect to particular embodiments, it is not thus limited. Numerous modifications changes and improvements within the scope of the invention will occur to the reader.

1. A smart device, comprising:
a data storage apparatus on the smart device;
a plurality of data resources in the data storage apparatus on the smart device;
a user role determination apparatus on the smart device for determining the role of a user requesting access to at least one of the plurality of data resources; and
at least one permission apparatus on the smart device operative to receive the role of the user from the user role determination apparatus and to control based on the role of the user the access of the user to the plurality of data resources.

2. The smart device of claim 1 wherein the plurality of data resources include at least one data resource from the group comprising a file, applet, application, program, directory, folder and an accessible data component.

3. The smart device of claim 1 wherein the role of a user is selected from the group comprising a public role, a cardholder role, an order fulfillment role, an administrative role, a miscellaneous role, a customized role and a super user role.

4. The smart device of claim 1 wherein the user role determination apparatus is responsive to a digital authentication key.

5. The smart device of claim 1 wherein the at least one permission apparatus grants at least one access selected from the group including: read, insert, update, delete, grant, grant with option, revoke, alter and customized access.

6. The smart device of claim 1 and further including a user identity determination apparatus for determining the identity of the user.

7. The smart device of claim 1 wherein the smart device comprises a smart card.

8. A method for selectively controlling access by multiple users to a plurality of data resources on a smart device, comprising the steps of:
determining the identity of a user requesting access to at least one of the plurality of data resources on the smart device;
determining the role of the user; and
controlling, based on the role of the user, the access of the user to the plurality of data resources.

9. The method of claim 8 wherein the plurality of data resources include at least one data resource from the group comprising a file, applet, application, program, directory, folder and an accessible data component.

10. The method of claim 8 wherein the step of determining a role of the user includes the step of receiving a digital authentication key.

11. The method of claim 10 wherein the role of a user is selected from the group comprising a public role, a cardholder role, an order fulfillment role, an administrative role, a miscellaneous role, a customized role and a super user role.

12. The method of claim 8 wherein the step of controlling the access of the user includes granting at least one access from the group including: read, insert, update, delete, grant, grant with option, revoke, alter and customized access.

13. A method of operating a smart device containing a plurality of data resources, comprising the steps of:
receiving from a user a request to access at least one of the plurality of data resources on the smart device;
determining a role of the user requesting access to at least one of the plurality of data resources;
determining a plurality of permissions stored on the card; and
supporting, based on the role of the user and the plurality of permissions, access of the user to at least one of the plurality of data resources.

14. The method of claim 13 wherein the plurality of data resources include at least one data resource from the group comprising a file, applet, application, program, directory, folder and an accessible data component.

15. The method of claim 13 wherein the role of a user is selected from the group comprising a public role, a cardholder role, an order fulfillment role, an administrative role, a miscellaneous role, a customized role and a super user role.

16. The method of claim 13 wherein the plurality of permissions include at least two permissions selected from the group of permissions including: read, insert, update, delete, grant, grant with option, revoke, alter and customized permission.

17. A system for operating a smart device containing a plurality of data resources, comprising:
receiving apparatus connected to receive a user request to access at least one of the plurality of data resources on the smart device;
determining apparatus connected to receive the request from the user and determine a role of the user;
a memory on the smart device storing a plurality of permissions; and
permissioning apparatus responsive to the role of the user and the plurality of permissions to provide access to the user to at least one of the plurality of data resources.

18. The system of claim 17 wherein the plurality of data resources include at least one data resource from the group comprising a file, applet, application, program, directory, folder and an accessible data component.

19. The system of claim 17 wherein the role of a user is selected from the group comprising a public role, a cardholder role, an order fulfillment role, an administrative role, a miscellaneous role, a customized role and a super user role.

20. The system of claim 17 wherein the plurality of permissions includes at least two permissions selected from the group of permissions including: read, insert, update, delete, grant, grant with option, revoke, alter and customized permission.

21. The system of claim 17 wherein the smart device is a smart card.
